(19) United States
(12) Patent Application Publication
(10) Pub. No.: US 2024/0384915 A1
(43) Pub. Date: Nov. 21, 2024

(54) ICE MELTING DEVICE AND METHOD OF MELTING ICE IN AN ICE BIN USING SAME

(71) Applicant: Timothy Weigel, Henderson, NV (US)

(72) Inventor: Timothy Weigel, Henderson, NV (US)

(21) Appl. No.: 18/319,925

(22) Filed: May 18, 2023

(51) Int. Cl. F25C 5/08

(52) U.S. Cl. CPC F25C 5/08; F25C 2500/08; F25C 2700/12

(57) ABSTRACT

An ice melting device is configured to be placed on top of the ice in an ice bin and melt the ice as it drops down into the ice bin as the ice melts. An ice melting device has a housing that is heated to an elevated temperature by a heating element drawing power from a battery within the housing. The housing of the ice melting device may be planar, having a thickness that is a small fraction of the length or width. A temperature display may indicate the temperature of the ice melting device. A battery may be a rechargeable battery that is charged through a charging port and a battery indicator may indicate a state of charge of the battery. A cover may extend over the control panel and may form a waterproof seal over the control panel.

### BACKGROUND OF THE INVENTION

### Field of the Invention

The invention relates to an ice melting device configured to melt ice in an ice bin.

### Background

Restaurants and bars often keep an ice bin full of ice for filling drink glasses, filling platters for oysters, or buckets for cold beverages. Theses ice bins are filled periodically to expedite work flow. When the establishment is closing the ice bin has to be cleaned and this means any remaining ice is typically melted with hot water, commonly referred to as “burning the ice.” Often, an ice bin is a sink having a water faucet and the hot water will be turned on to melt the ice. In cases with no faucet, a hose is typically extended from a hot water tap over to the ice bin, which gets in the way. Burning the ice takes a long period of time and wastes a lot of heated water, which costs money to heat. Water waste is never a good idea, but even more so considering today's circumstances with so many states in the United States being in a drought condition. Some states have water restrictions and residents and business are being asked to reduce their water consumption.

In addition, during the burning the ice process, water may spill or spray out of the ice bin causing wet floors and a hazardous condition for employees. The ice bins may be plugged to prevent the hot water from just forming a hole through the ice and running straight down the drain, but this means that the water level in the ice bin has to be monitored to avoid an overflow situation.

Additionally, the ice cannot be scooped out of an ice bin and be reused due to sanitary considerations. Also, cleaning and sanitizing surfaces in the kitchen area has become more important with the advent of Covid-19. Surfaces in kitchens are routinely disinfected for cleanliness and to reduce chances of spreading infectious diseases.

Ice bins are routinely washed with a cleaning and/or sanitizing chemicals and these chemicals may remain in the ice bin, along the walls, if not properly washed and rinsed off. This can lead to the ice having a bad or chemical taste.

Bars and restaurants come in all sizes and capacities. The costs of water used in commercial establishments can vary greatly to, not only from city to city and state to state, but even season to season. However, what it comes down to in rough estimates is: bars and restaurants have an average of four underbar ice bins, and an average of 5700 gallons of water used every day for an average of 311 days of business every year. If just over two percent of that daily water volume is used for burning ice, that comes to an average of about 40,000 gallons per establishment every year. Now multiply that by over 720,000 restaurants, bars and nightclubs in the U.S. This comes to 28.8 billion gallons of water that can be saved in a single year, and just by this one task at bars and restaurants.

The average annual cost for that water, including regional and season variations, is over $250 annually per facility. On average that is how much each facility loses every year just on the water used to burn ice. There is a lot more going down the drain, though. Add in the costs of electricity or gas to heat that wasted water, and the costs of labor wasted waiting for the ice to melt before ice bins can be cleaned, and these factors come to an additional $500 wasted every year. Therefore, the total cost for burning the ice is about $750 per year.

### SUMMARY OF THE INVENTION

The invention is directed to an ice melting device configured to melt ice in an ice bin. An exemplary ice melting device is configured to be placed on top of the ice in an ice bin and melt the ice as it drops down into the ice bin as the ice melts. An ice melting device has a housing that is heated by a heating element to a temperature to enable the ice to be quickly melted. This saves time and money by eliminating the need for running hot water into the ice bin and the need for constant monitoring of the ice bin to prevent overflow. Furthermore, the temperature produced by the ice melting device within the ice bin may be high enough to disinfect the walls of the ice bin and therefore reduce or eliminate the need for further cleaning and any chemical tastes of the ice from cleaning and sanitizing chemicals. A light element may produce a light that disinfects the sink, such as a UV light.

An exemplary ice melting device has a housing that is planar, having a thickness that is a small fraction of the length or width. This planar housing is configured to be placed directly onto the ice within an ice bin and melt the ice. A heating element, such as an electrically resistive heating element, may be configured over the planar housing and be dispersed over the area to provide effectively uniform heat distribution for heating the ice in the ice bin. An electrically resistive heating element, such as a metallic wire, may serpentine over the area of the housing for effective distribution of heat. The heating element may be powered by a battery configured with the ice melting device and the battery may be a rechargeable battery, charged through a charging port.

An exemplary ice melting device has a control panel that a user may interface to activate the device. The control panel may have an on/off switch, a temperature display and a battery indicator. Also, the charging port for the battery may be configured on the control panel. A user may switch on the ice melting device using the on/off switch and the temperature of the ice melting device may be displayed on the temperature display. A user may wait for the ice melting device to heat to a desired or set temperature before placement on the ice, or may lay the ice melting device over the ice and turn it on to begin the burning ice process. An exemplary battery indicator may be a light that turns on or off to indicate a battery level or state of charge or may be a particular color to indicate a state of charge over an upper threshold state of charge and a different color when below a lower threshold state of charge. For example, the light may be green to indicate an effective amount of charge and then turn yellow when the state of charge drops below a lower threshold value or level.

The control panel may be waterproof and may have a seal to prevent water from contacting the components. A control panel cover may be configured over the control panel to form a waterproof seal, such as through a gasket. In an exemplary embodiment, the control panel has a control gasket and the control panel cover has a cover gasket that aligns with the control gasket to form a waterproof seal. A user may open the control panel cover, turn on the ice melting device, and then close the cover. In an exemplary embodiment, the control panel cover is coupled to or over the control panel by a hinge and the control panel cover is retained over the control panel by a latch. The control panel may be opened by rotating the control panel cover via the hinge and then rotated closed and retained in a closed position by the latch. When closed, the cover gasket and control gasket are pressed together in compression to form a waterproof seal.

The housing of the ice melting device may be planar and have a size configured to extend over a substantial portion of an ice bin or sink area. The length may be about 25 cm or more, about 35 cm or more, about 50 cm or more, about 60 cm or more, about 75 cm or more and any range between and including the values provided. The width may be about 25 cm or more, about 35 cm or more, about 50 cm or more, about 60 cm or more, about 75 cm or more and any range between and including the values provided. The housing may be a planar housing and have a thickness that is no more than about 5.0 cm, no more than about 3 cm, no more than about 2 cm, no more than about 1.0 cm and any range between the thickness values provided. The thickness therefore may be a fraction of the length and width, wherein the thickness is no more than a tenth the length or width, or even no more than a twentieth of length or width of the housing.

The housing may include surfaces and covers, wherein the top planar surface has the temperature indicator thereon is an indicator surface that may have an indicator surface cover. The bottom planar surface or the ice-contact surface may have an ice-contact cover. The ice-contact cover and indicator surface cover may be waterproof and comprise a polymer or plastic layer that prevents the passage of water therethrough. The ice-contact cover and indicator surface cover may be sealed around a perimeter of the housing to form a waterproof enclosure. The heating element and battery may be configured in this enclosure formed by the ice-contact cover and indicator surface cover and an insulator layer may be configured within the housing to insulate the heating element from heating the indicator surface and to protect the heating element. An insulating layer may be a foam or other material having high thermal insulating properties and may be configured to withstand the temperature of the housing or the heating element, such as at least 120° F. or more, about 140° F. or more, about 150° F. or more, about 165° F. or more, about 180° F. or more and any range between and including the temperature values provided. The insulator layer may be a silicone foam, such as a closed cell silicone foam. An exemplary foam layer may have a thermal insulation value or R-value of about 6 per inch or more, about 6.5 per inch or more, about 7 per inch or more, about 7.5 or more and any range between and including the values provided. The insulator layer may be configured between the heating element and the indicator surface cover and may also be configured between the heating element and the ice-contact surface and ice-contact cover. Again, an insulator layer extending over the heating element may reduce heat loss out from the indicator surface and enable melting the ice within the ice bin with less power. Also, the insulator layer may be a compressible and resilient material, such as a foam, wherein the foam can be compressed and then return to an original thickness upon removal of a compression force.

The heating element may heat the housing or the ice-contact surface to a temperature of about 120° F. or more, about 140° F. or more, about 150° F. about 165° F. or more, about 180° F. or more and any range between and including the temperature values provided. A higher temperature may melt the ice more quickly. A temperature may be achieved within the ice bin that effectively disinfects the sink, such as the sink surfaces. A temperature sensor, such as a thermocouple, may be configured to measure the temperature of the heating element or the housing and this temperature may be displayed on the temperature display. A controller, such as a microchip, may receive the temperature from the temperature sensor and may control the amount of power or current provided to the heating element to maintain a temperature within certain limits. The controller may also receive the battery state of charge and may control the battery indicator, such as the light color or turning on and off the light as required for indicating the battery level.

An exemplary ice melting device may have a light element that produces a disinfecting light that effectively disinfects the sink. The light element may be configured to project light from the ice-contact surface and the ice-contact cover may be translucent or transparent to allow the light to project through the cover. The light produced by the light element may be an ultraviolet light (UV) and may be a UV-C light that effectively disinfects the ice bin and is safe for human exposure. A neutralizing UV-C light may prevent any pathogens, such as a virus from replicating and thereby prevent infection by the virus while a destroying UV light may destroy the virus by breaking or more molecular bonds in the RNA or DNA of the virus. UV-C light is light with a wavelength of about 222 nm (nanometers), and may have wavelengths in a narrow band around 222 nm, such as within about 10 nm, preferably within 5 nm, and even more preferably within about 2 nm of 222 nm. This narrow UV-C band has been shown to be relatively safe for use around humans since it does not penetrate the skin below the dead skin (epidermis) layer and does not penetrate the outer layers of the eyeball. A light element may also produce a destroying UV light, such as a UV light with a wavelength of about 270 nm or within about 10 nm, preferably within about 5 nm and even more preferably within about 2 nm of 270 nm. A disinfecting light, as used herein, may be a UV-C light that neutralizes pathogens or a UV light that destroys pathogens.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective view of an exemplary ice bin used in many restaurants and bars.

FIG. 2 shows a perspective view of an exemplary ice melting device configured over ice in an ice bin.

FIG. 3 shows a perspective view of the exemplary ice melting device shown in FIG. 2 after the ice has partially melted.

FIG. 4 shows a perspective view of the exemplary ice melting device shown in FIG. 2 after the ice has melted.

FIG. 5 shows an indicator surface of the ice melting device having a controller with a temperature display to indicate the temperature of the ice melting device.

FIG. 6 shows an ice-contact surface of the ice melting device having a heating element to heat the ice melting device to enable melting of ice in an ice bin.

FIG. 7 shows an enlarged view of the control panel for the ice melting device having a temperature display, an on/off switch, a charging port, and a battery indicator.

FIG. 8 shows an enlarged view of the control panel shown in FIG. 5 with a charging cable plugged into the charging port.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

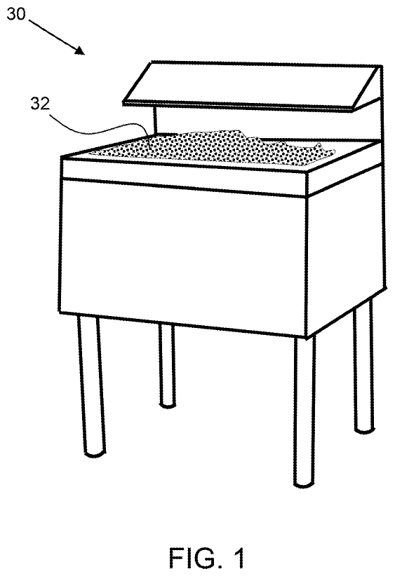

As shown in FIG. 1, many restaurants and bars use an ice bin 30 for the quick availability of ice 32 for drinks, and certain food items, like oysters. A glass may be quickly filled with ice from the ice bin and the ice bin may be refilled as required. The ice in the ice bin however has to melt before the ice bin can be cleaned. Regulations require periodic cleaning of the ice bin as this is a food contact surface and waiting for a large amount of ice to melt can take a long time. Hot water can be poured over the ice but this can result in the ice bin overflowing and causing a mess that produces a hazard due to the wet floor.

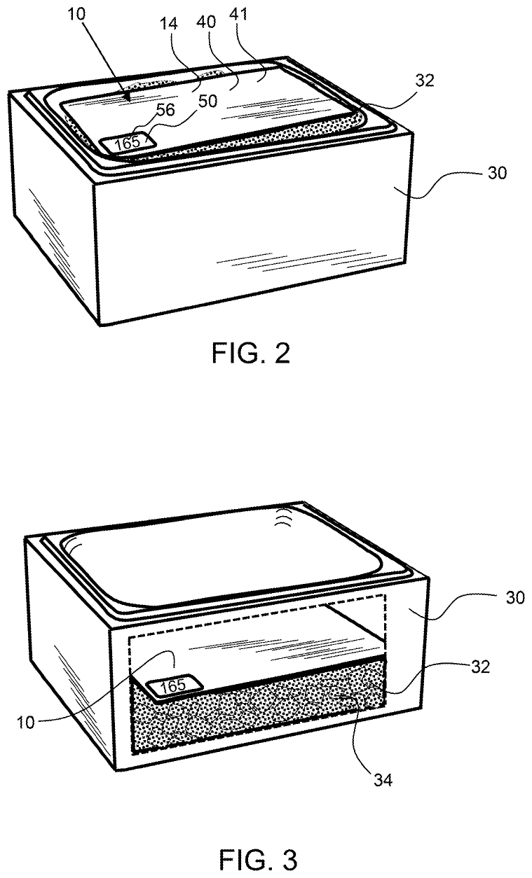

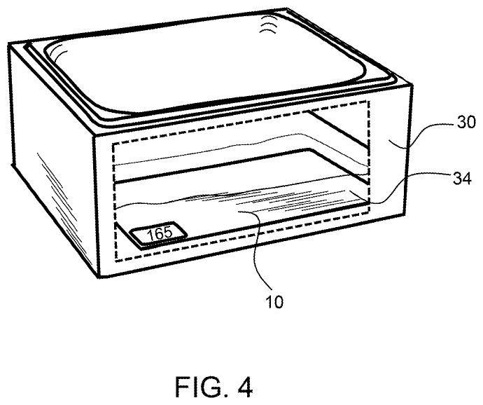

Referring now to FIGS. 2 to 4, an exemplary ice melting device 10 is configured over ice 32 in an ice bin 30. The ice may be cubed ice or be separate ice pieces. The ice melting device 10 is configured in a housing 14 that is heated to an elevated temperature, as described herein, and melts the ice due to direct heat transfer to the ice. The planar ice melting device has an indicator surface 40 that has a control panel 50 with a temperature display 56, that shows the elevated temperature, 165° F., as shown. An indicator surface cover 41 extends over the planar indicator surface 40. As shown in FIG. 2 the ice melting device is configured over the ice 32 in a full ice bin 30. As shown in FIG. 3, the ice melting device 10 has lowered down into the ice bin 30 after the ice has partially melted. As shown in FIG. 4, the ice 32 is completely melted to form water 34 and the ice melting device 10 is submerged in the water.

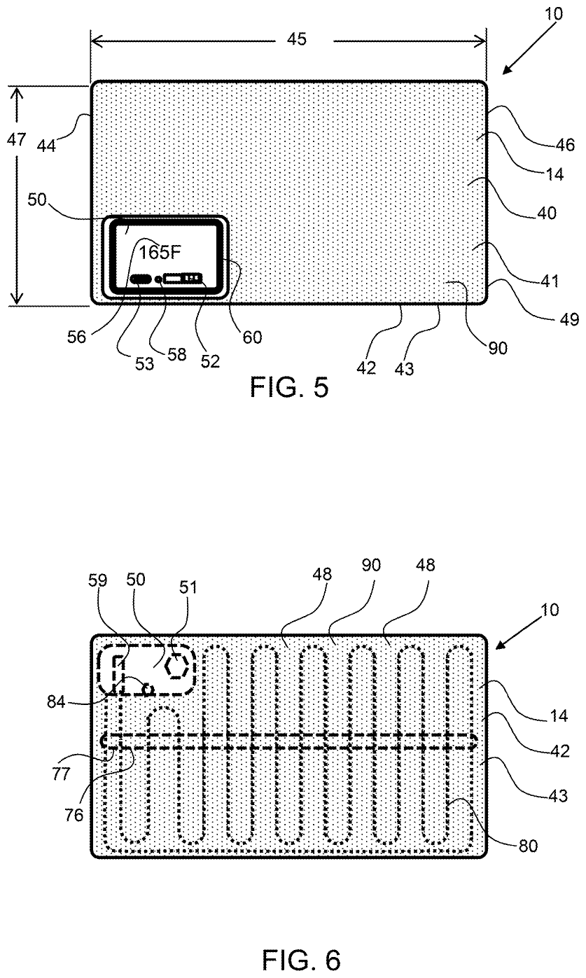

As shown in FIG. 5, an exemplary ice melting device 10 has a housing 14 with a control panel 50 having a temperature display 56 to indicate the temperature or the ice melting device, a charging port 53, a battery indicator 58 to indicate a battery level, and an on/off switch 52. The indicator surface 40 has an indicator surface cover 41 that prevents liquid water from penetrating therethrough. As shown, the ice melting device 10 is rectangular in shape, having a length 45 from a first end 44 to a second end 46 that is greater than a width 47 from a first side to a second side. A seal 49 may seal the indicator surface cover 41 to the ice-contact cover 43 around the perimeter of the housing 14. The ice melting device may be planar, having a thickness from an indicator surface 40 to the ice-contact surface 42, opposite the indicator surface, that is no more than about 15 mm, or no more than about 25 mm, no more than about 35 mm and any range between and including the thickness values provided. An insulator layer 90 may be configured within the housing 14 and as described herein may be configured between the heating element (not shown in FIG. 5) and the indicator surface cover 41, to insulate heat from dissipating out from this surface.

As shown in FIG. 6, the exemplary ice-contact surface 42 of the ice melting device has an ice-contact cover 43 that prevents liquid water from penetrating therethrough. The ice-contact cover 43 and the indicator surface cover 41 shown in FIG. 5 may form a waterproof housing for the ice melting device. A heating element 80, such as a resistive heater that extends across the interior of ice melting device to provide distribution of the heat to melt ice. The heating element receives power from the battery 59. A controller 51 may control the amount of current or power delivered to the heating element 80 to maintain a desired elevated temperature. A temperature sensor 84, such as a thermocoupler, may be configured to measure the temperature of the ice melting device and may be coupled to provide this measured temperature to the controller 51. The heating element is shown in dashed lines as it is configured within an enclosure 48 of the housing 14 of the ice melting device 10.

As shown in FIG. 6, a light element 76 is configured to project light from the ice-contact surface 42. As described herein, the light element may produce disinfecting light 77. such as a UV light and preferably a UV-C light with a wavelength of about 222 nm.

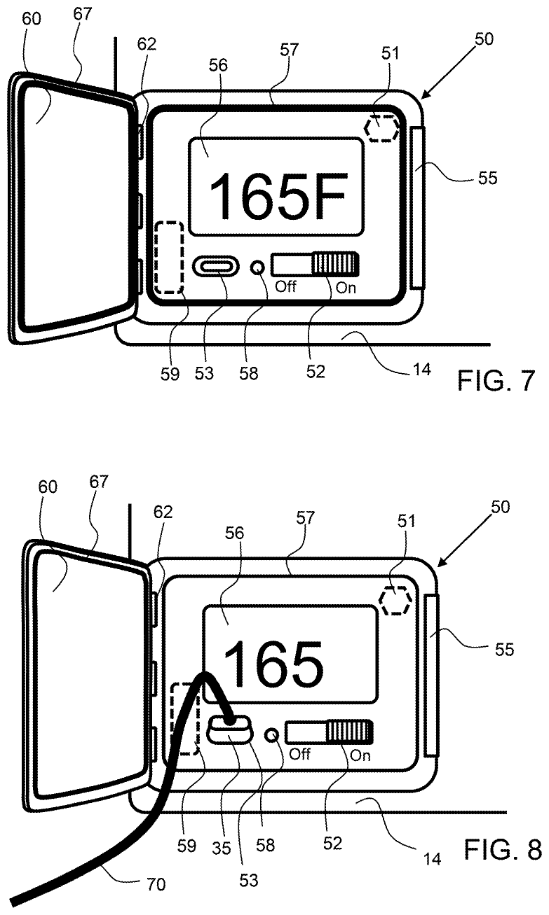

Referring now to FIGS. 7 and 8, an exemplary control panel 50 of the ice melting device 10 has a temperature display 56, an on/off switch 52, a charging port 53, and a battery indicator 58. A battery 59 and controller 51, such as a microchip or circuit, may be configured with the control panel 50 as well. The temperature display 56 may indicate the temperature measured by a temperature sensor coupled to the ice melting device. The charging port 53 may be a Universal Serial Port (USB) type charging port. The battery indicator may be a light that turns on when the battery is low or preferably changes color from a first color, such as green, when the battery is effectively charged above a threshold state of charge or voltage to a second color, such as yellow or red, when the battery has dropped below a threshold state of charge or voltage. The control panel 50 may have a control panel cover 60 that produces a waterproof seal over the control panel 50. The control panel cover 60 may be coupled to the control panel 50 by a hinge 62 and may have a cover gasket 67 configured to align with the control gasket 57 to produce a waterproof seal. The cover 60 may rotate about the hinge 62 and then be retained by the latch 55 in a closed position. As shown in FIG. 8, a charging cable 70 is plugged into the charging port 53.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A method of melting ice in an ice bin, comprising:
a) providing an ice melting device comprising:
i) a housing;
ii) a battery;
iii) a heating element coupled within the housing and configured to receive electrical power from the battery to heat the housing to an elevated temperature;
iv) a temperature sensor to measure said elevated temperature;
v) a temperature display that displays said elevated temperature; and
vi) an on/off switch;
wherein the housing is planar, having a thickness of no more than 50 mm and a length and width that is at least 20 cm;
b) turning on the ice melting device with the on/off switch;
c) placing the ice melting device over said ice in the ice bin; and
d) allowing the heating element to heat the housing and melt the ice in the ice bin;
wherein the ice melting device drops with the ice within the ice bin as the ice melts.

2. The method of claim 1, wherein the housing is waterproof.

3. The method of claim 1, wherein the ice melting device further comprises a charging port coupled with the battery to charge the battery and wherein the battery is a rechargeable battery.

4. The method of claim 3, wherein the charging port is a Universal Serial Port (USB).

5. The ice melting device of claim 1, further comprising a battery indicator.

6. The method of claim 1, wherein the ice melting device further comprises a battery indicator that comprises a light.

7. The method of claim 1, wherein the heating element is an electrically resistive heating element.

8. The method of claim 7, wherein the resistive heating element forms a loop from the battery.

9. The method of claim 7, wherein the resistive heating element is configured in a serpentine configuration over the housing to heat the housing.

10. The method of claim 9, wherein the heating element heats the housing to an elevated temperature of at least 150° F.

11. The method of claim 1, wherein the ice melting device further comprises a control panel and wherein the temperature display is configured on the control panel.

12. The method of claim 11, wherein the ice melting device further comprises a charging port that is configured on the control panel.

13. The method of claim 11, wherein the ice melting device further comprises battery indicator configured on the control panel.

14. The method of claim 11, wherein the ice melting device further comprises an on/off switch that is configured on the control panel.

15. The method of claim 11, wherein the ice melting device further comprises a control panel cover configured to seal onto the control panel to prevent water from contacting the control panel.

16. The method of claim 15, wherein the ice melting device further comprises a cover gasket configured to seal the control panel cover to the control panel to produce a waterproof seal.

17. The method of claim 16, wherein the control panel cover further comprises a cover gasket configured to align with the control gasket to produce said waterproof seal.

18. The method of claim 1, further comprising an insulating layer configured in the housing.

19. The method of claim 1, wherein the insulating layer is a foam having a R-Value of at least 5.0 per inch.

20. The method of claim 1, wherein the ice melting device further comprises a light element that produces a disinfecting light.

21. The method of claim 20, further comprising a translucent ice-contact surface cover that allows the disinfecting light to pass therethrough.
